(19) United States
(12) Patent Application Publication
(10) Pub. No.: US 2013/0042595 A1
(43) Pub. Date: Feb. 21, 2013

(54) PULSE DETONATION COMBUSTOR WITH PLENUM

(71) Applicants: Adam Rasheed, Glenville, NY (US); Venkat Tangirala, Niskayuna, NY (US); Narendra Joshi, Schenectady, NY (US); Ross Kenyon, Waterford, NY (US)

(72) Inventors: Adam Rasheed, Glenville, NY (US); Venkat Tangirala, Niskayuna, NY (US); Narendra Joshi, Schenectady, NY (US); Ross Kenyon, Waterford, NY (US)

(73) Assignee: GENERAL ELECTRIC COMPANY, Schenectady, NY (US)

(21) Appl. No.: 13/210,603

(22) Filed: Aug. 16, 2011

(51) Int. Cl. F02K 7/02

(52) U.S. Cl. 60/247

(57) ABSTRACT

A pulse detonation combustor includes at least one plenum located along the length of the pulse detonation combustor. The plenum can be located: 1) proximate an air valve; 2) between a fuel injection port and an ignition source; 3) downstream of both the fuel injection port and the ignition source; and 4) proximate an exit nozzle of the pulse detonation combustor. In addition, the pulse detonation combustor can have multiple plenums, for example, proximate the air valve and proximate the exit nozzle. The location and dimensions of the plenum can be selectively adjusted to control mechanical loading on the wall, the velocity of fluid flowing within the combustor, and the pressure generated by the pulse detonation combustor.

### BACKGROUND OF THE INVENTION

This invention relates to pulse detonation systems, and more particularly, to a pulse detonation combustor (PDC) with at least one plenum for lowering the peak of the pressure pulse and extending the duration of the plateau and blowdown time.

With the recent development of pulse detonation combustors (PDCs) and pulse detonation engines (PDEs), various efforts have been underway to use PDC/Es in practical applications, such as combustors for aircraft engines and/or as means to generate additional thrust/propulsion in a post-turbine stage. Further, there are efforts to employ PDC/E devices into “hybrid” type engines that use a combination of both conventional gas turbine engine technology and PDC/E technology in an effort to maximize operational efficiency.

One of the key advantages of a pulse detonation engine (PDE) is the pressure-rise combustion that leads to increased performance by attaining a quasi-constant volume thermodynamic cycle. The challenge is that practical PDE applications require pulsed operation due to the unsteady nature of detonations. The pressure-rise is, therefore, attained for only a very brief period of time. A typical pressure-trace shows a very high pressure spike (lasting approximately 5 microseconds), followed by a plateau that can last 2-3 milliseconds, followed by a blowdown to a lower ambient (or fill) pressure. The duration of the plateau and blowdown is largely a function of the tube volume and exit nozzle area ratio. It is desirable to lower the ‘peak’ of the pressure pulse (which can be harmful to upstream and downstream components) and extend the duration of the plateau and blowdown.

### BRIEF SUMMARY OF THE INVENTION

The inventors have solved the problem of lowering the peak of the pressure pulse and extending the duration of the plateau and blowdown time for a PDC by providing at least one plenum along the length of the PDC. The plenum can either be upstream or downstream of the fuel injection port and ignition source. The plenum can be used instead of, or in conjunction with, a downstream exit nozzle that also assists in extending the blowdown time.

In one aspect of the invention, a pulse detonation combustor having a wall and comprising at least one plenum along a length of the pulse detonation combustor for controlling one of a mechanical loading on the wall, a velocity of fluid flowing within the combustor, and a pressure generated by the pulse detonation combustor.

As used herein, a “pulse detonation combustor” PDC (also including PDEs) is understood to mean any device or system that produces both a pressure rise and velocity increase from a series of repeating detonations or quasi-detonations within the device. A “quasi-detonation” is a supersonic turbulent combustion process that produces a pressure rise and velocity increase higher than the pressure rise and velocity increase produced by a deflagration wave. Embodiments of PDCs (and PDEs) include a means of igniting a fuel/oxidizer mixture, for example a fuel/air mixture, and a detonation chamber, in which pressure wave fronts initiated by the ignition process coalesce to produce a detonation wave. Each detonation or quasi-detonation is initiated either by external ignition, such as spark discharge or laser pulse, or by gas dynamic processes, such as shock focusing, auto ignition or by another detonation (i.e. cross-fire).

As used herein, a “detonation” is understood to mean either a detonation or a quasi-detonation.

As used herein, “engine” means any device used to generate thrust and/or power.

As used herein, a “plenum” means an enclosed chamber where fluid can collect that has a cross-sectional area that is larger than the remainder of the pulse detonation combustor.

### BRIEF DESCRIPTION OF THE DRAWINGS

The advantages, nature and various additional features of the invention will appear more fully upon consideration of the illustrative embodiment of the invention which is schematically set forth in the figures, in which:

FIG. 1 shows a diagrammatical representation of a pulse detonation combustor (PDC) with the plenum of the invention located proximate an air valve (i.e., upstream of both the fuel injection port and the ignition source).

FIG. 2 shows a diagrammatical representation of a pulse detonation combustor (PDC) with the plenum of the invention located between the fuel injection port and the ignition source (i.e., the plenum is downstream of the fuel injection port and upstream of the ignition source).

FIG. 3 shows a diagrammatical representation of a pulse detonation combustor (PDC) with the plenum of the invention located downstream of both the fuel injection port and the ignition source.

FIG. 4 shows a diagrammatical representation of a pulse detonation combustor (PDC) with the plenum of the invention located proximate an exit nozzle (i.e., downstream of both the fuel injection port and the ignition source).

FIG. 5 shows a diagrammatical representation of a pulse detonation combustor (PDC) with multiple plenums of the invention with one plenum located proximate an air valve (i.e., upstream of both the fuel injection port and the ignition source) and another plenum proximate an exit nozzle (i.e., downstream of both the fuel injection port and the ignition source).

FIG. 6 shows a graph of a typical pressure trace of a pulse detonation combustor (PDC) that does not have a plenum of the invention.

FIG. 7 shows a graph of a typical pressure trace of a pulse detonation combustor (PDC) that has a plenum of the invention.

### DETAILED DESCRIPTION OF THE INVENTION

The present invention will be explained in further detail by making reference to the accompanying drawings, which do not limit the scope of the invention in any way.

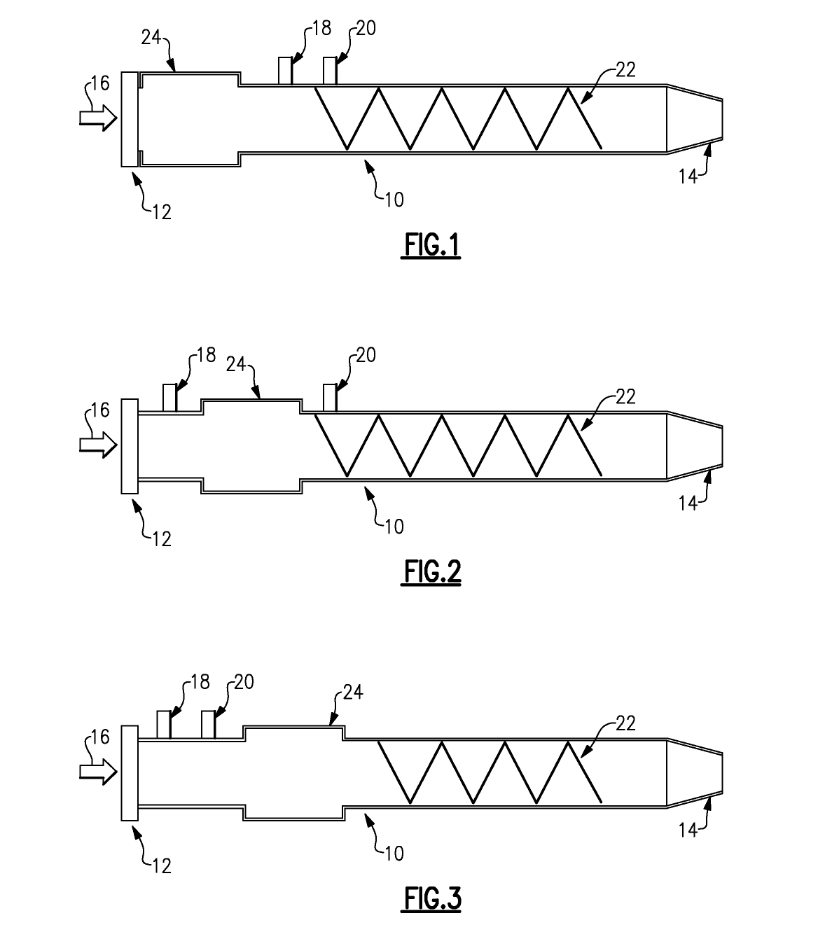

FIG. 1 depicts a pulse detonation combustor (PDC) 10 having an air valve 12 at one end and an exit nozzle 14 at an opposite end according to an embodiment of the invention. In the illustrated embodiment, the exit nozzle 14 is a converging nozzle. However, it will be appreciated that the exit nozzle 14 could also be a converging/diverging nozzle, rather than a converging nozzle. The air valve 12 can be of any type: disk, rotating can, poppet, sleeve valve, and the like. Airflow 16 for the combustor 10 can be provided from any conventional primary airflow source (not shown), for example, from a compressor stage of an engine (not shown), or comparable source. Fuel can be supplied to the combustor 10 by means of a conventional fuel injector port 18. The fuel injector port 18 may be controlled by any known or conventional means. In the present invention, it is contemplated that the valve 18 be controlled so as to modulate or regulate heat release from the working fuel. Namely, the fuel, and detonation, control is such that the generation of heat by the combustor 10 can be set to the appropriate level for efficient energy conversion by some downstream device.

In general, the operation and function of the pulse detonation combustor 10 is in accordance with any known or conventional means and methods. The present invention is not limited, in any way, to the operation and configuration of the pulse detonation combustor. The flow of the primary air into the combustor 10 may be controlled by the valve 12 to provide the proper fuel-air ratio conditions for sustainable detonations. The flow control may be achieved by any known or conventional means.

Alternatively, a premixed air/fuel mixture can be provided to the combustor 10 instead of airflow 16, and the fuel injector port 18 is not required and can be eliminated. An ignition source 20, such as a spark plug, and the like, ignites the fuel/air mixture within the PDC 10. The PDC 10 may also include an obstacle field 22 that impart turbulence and or swirl to enhance mixing of the fuel/air mixture within the PDC 10, thereby promoting detonation formation within the PDC 10. A benefit is to achieve a nearly uniform temperature profile that facilitates optimum energy conversion and robust design life of the downstream device. The obstacle field 22 can be in the form of spirals, blockage plates, ramps, and the like.

One aspect of the invention is that the PDC 10 includes a plenum 24 having a cross-sectional area that is larger than the cross-sectional area of the remainder of the PDC 10. For example, the plenum 24 can have a cross-sectional area that is between about 1.1 to about 2.0 times larger than the cross-sectional area of the remainder of the PDC 10. In one specific embodiment, the plenum 24 has a cross-sectional area that is approximately 1.4 times larger than the cross-sectional area of the remainder of the PDC 10.

One benefit of the additional volume provided by the plenum 24 is that the peak of the pressure pulse, which can be harmful to upstream (and downstream) components is lowered, and the duration of the plateau and blowdown of the pressure pulse is extended. Referring now to FIG. 6, the pressure trace of a conventional combustor without the plenum exhibits a pressure spike that rapidly drops to an initial value and has a relatively lower average pressure. As shown in FIG. 7, the pressure trace of the PDC 10 with the plenum 24 exhibits a pressure that is maintained longer and decreases slowly back to an initial value and the average pressure is higher. In effect, the plenum 24 extends the plateau and blowdown processes, thereby keeping the PDC 10 pressurized for a longer period of time.

The plenum 24 serves several purposes, which can be selectively adjusted by locating the plenum 24 at different locations along the PDC 10. These purposes include, but are not limited to:
1) Selectively controlling the mechanical loading on the combustor wall;
2) Selectively controlling the velocity of fluid flowing in the combustor; and
3) Selectively controlling the pressure generated by the combustor.

Each of these purposes is discussed below.

Mechanical Loading Control

A sudden change in cross-sectional area change from a small diameter to a larger diameter helps weaken detonation wave or shock wave, thereby reducing the dynamic impact load, which results in very high transient peak stresses, and also lowers the “average pressure” in the larger volume section. However, this larger diameter cross-sectional area results in a larger surface area for pressure to act on, so it could result in a higher static load (so there is a trade-off of dynamic load vs static load).

In general, the best location of the plenum 24 for mechanical loading is proximate the air valve 12. If the plenum 24 is upstream of the fuel injector port 18 and ignition source 20, then fuel does not enter the plenum 24 (i.e., the plenum is unfueled). At this location, there are multiple benefits:
1) Lower peak pressure because detonation wave converted to shock wave;
2) Lower temperature, and therefore better for materials because there is little or no combustion near the air valve; and
3) Lower peak pressure due to weakening of detonation/shock wave due to sudden area change, but there is a trade-off with potential higher static stress due to hoop stress.

Flow Velocity Control

Much of the flow processes, for example, fuel fill, detonation initiation, blowdown, and the like, are impacted by the bulk flow velocity. At a high level, the bulk-flow velocity in the PDC 10 is principally controlled by the mass flow rate, density (e.g., P and T), the diameter of the PDC 10, and the throat area of the exit nozzle 14. The local bulk flow velocity can be adjusted along the length of the PDC 10 by selectively adjusting the local diameter of the PDC 10. This could be helpful in at least two areas:
1) Proximate the exit nozzle 14 to help minimize fuel spillage. For example, having larger diameter locally slows the bulk flow. When trying to fill the tube with fuel close to 100% of the length, you might accidently overfill (resulting in fuel wastage). By having a locally larger diameter near the end, it slows the flow-down and makes a “buffer region” to allow for slight variations in the flow velocities without resulting in an overfill.
2) Between the air valve 12 and the exit nozzle in the middle of the PDC 10 in the region of the obstacle field 22. The locally smaller diameter increases the bulk velocity and increases the amount of turbulence and mixing to make the DDT process more effective. However, there is a trade-off because smaller diameter implies higher velocity, which might provide more effective DDT, but higher pressure drop.

Pressure Control

In general, the larger the tube volume, the higher the average pressure-rise will be achieved. Having locally larger diameters anywhere can help increase the pressure-rise and extend the blowdown time (trade-offs are with nozzle throat diameter and frequency of operation).

It is envisioned that the plenum 24 can be located at five (5) different locations along the PDC 10. These locations include, but are not limited to,
1) Upstream of the fuel injector and proximate the air valve 12;
2) Between the fuel injector and the ignition source;
3) Downstream of the ignition source along the mid-length of the PDC 10;
4) Proximate the exit nozzle 14;
5) Both 1) and 4); and
6) Any combination of the above.

Each location 1) through 5) impacts the mechanical loading control, flow velocity control and the pressure rise control of the PDC 10 in a different manner. In the illustrated embodiment shown in FIG. 1, the plenum 24 is located proximate the air valve 12 at one end of the PDC 10 upstream of both the fuel injector port 18 and the ignition source 20. At this location, the plenum 24 represents a sudden change in cross-sectional area to an upstream traveling shock (retonation) wave. The plenum 24 is unfueled and simply gets pressurized when the retonation wave arrives at the air valve 12. The larger volume provided by the plenum 24 extends the plateau and blowdown time of the retonation wave. In addition, the retonation wave slightly weakens and the peak of the retonation wave is lowered, thereby providing a mechanical benefit to the air valve 12. Further, the plenum 24 can be tuned to take advantage of acoustic modes of the PDC 10 and to assist the fill and purge processes.

Referring now to FIG. 2, another location for the plenum 24 is between the fuel injector port 18 and the ignition source 20 (i.e., downstream of the fuel injector port 18 and upstream of the ignition source 20). At this location, the plenum 24 is fueled (the fueling point can either be upstream of the air valve 12, downstream of the air valve 12, or both). As a result of being fueled, the plenum 24 experiences pressurization and deflagration combustion from the retonation wave and hot exhaust products. The larger volume provided by the plenum 24 extends the plateau and blowdown time of the retonation wave. In addition, the retonation wave slightly weakens and the peak is lowered, thereby providing a mechanical benefit to the air valve 24. However, the plenum 24 may cause potentially higher stresses locally due to the larger diameter (and stress is proportional to diameter).

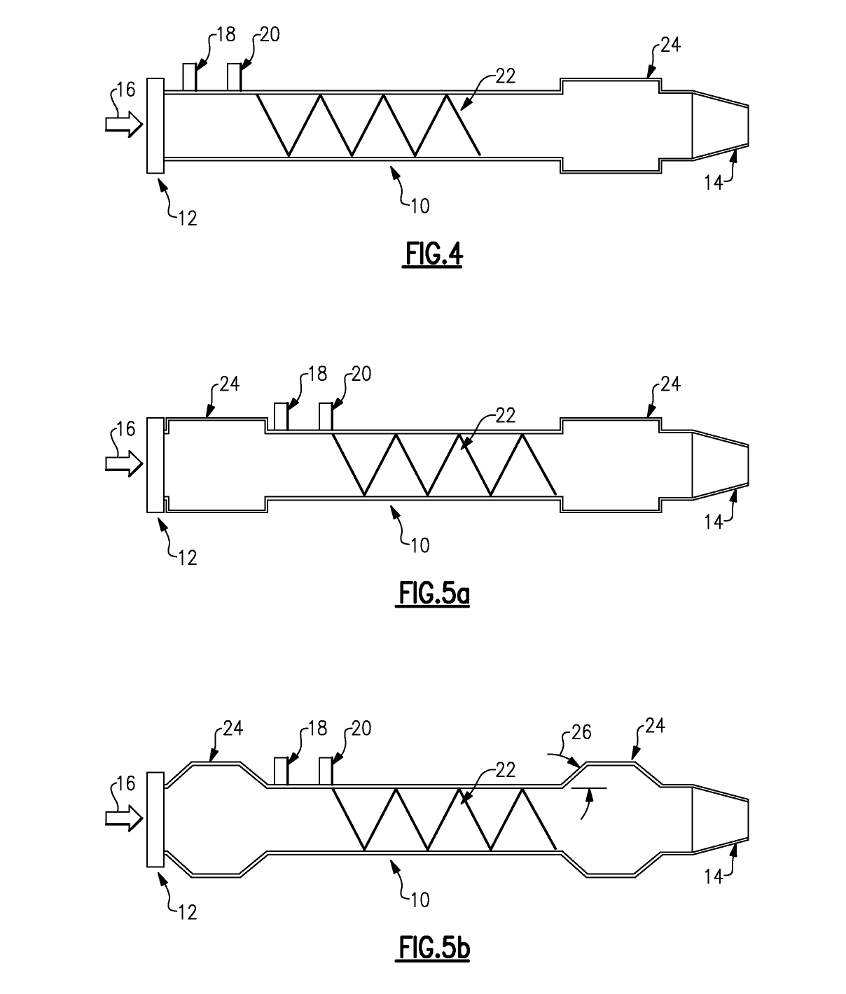

Referring now to FIG. 3, another location for the plenum 24 is downstream of the fuel injector port 18 and the ignition source 20. At this location, the plenum 24 is fueled (the fueling point can either be upstream of the air valve 12, downstream of the air valve 12, or both). As a result of being fueled, the plenum 24 experiences pressurization and deflagration combustion from the retonation wave and hot exhaust products. The larger volume provided by the plenum 24 extends the plateau and blowdown time of the retonation wave. In addition, the plenum 24 can be tuned to take advantage of acoustic modes of the PDC 10 and to assist the fill and purge processes.

Referring now to FIG. 4, another location for the plenum 24 is proximate the exit nozzle 14. At this location, the plenum 24 can be fueled or unfueled, depending on the desired fill fraction of the PDC 10. The larger volume provided by the plenum 24 can be used to enhance control of the fill fraction because the PDC 10 relies on the bulk flow velocity to convect fuel along its length. The locally larger diameter provided by the plenum 24 lowers the bulk-flow velocity, thereby lessening any errors/jitter in fuel fill time to prevent over or under filling. The larger volume provided by the plenum 24 also extends the plateau and blowdown time of the detonation and retonation wave. In addition, the plenum 24 can be tuned to take advantage of acoustic modes of the PDC 10 and to assist the fill and purge processes. The increased volume helps increase the residence time of the burnt gases in the combustor. This increase in residence time permits chemical reaction to go to completion. The increase in volume is also used to tailor the operating frequency of the PDC. Increased area at the back end (i.e., near exit nozzle 14) also lowers the flow velocity in the hottest part of the combustor, which facilitates cooling of the combustor walls.

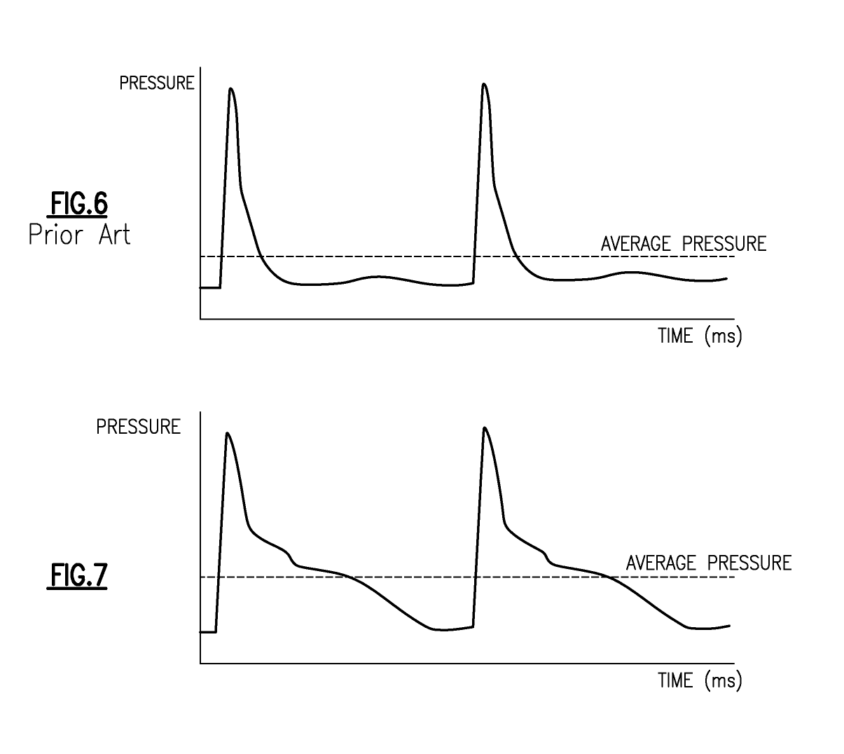

It will be appreciated that the invention can have multiple plenums 24 along the length of the PDC 10 to accomplish tailoring of the pressure, velocity and/or mechanical loading as needed. FIG. 5 illustrates an exemplary embodiment of the invention with multiple plenums 24 along the length of the PDC 10. In the illustrated embodiment, one plenum 24 is proximate the air valve and another plenum 24 is proximate the exit nozzle 14. It is noted that this configuration highlights another type of velocity control that is implicit in all the previous figures, but made much more obvious here. In FIG. 5, it is clear that the obstacle field 22 is in a reduced diameter section of the PDC 10. This location for the obstacle field 22 is usually helpful because it increases the local velocity, which increases the turbulence within the obstacles, thereby improving the effectiveness of the detonation formation.

In the illustrated embodiment, the transition between the plenum 24 and the remainder of the combustor 10 is an abrupt angle 26 of about ninety degrees (i.e., perpendicular to the wall of the PDC 10). However, it will be appreciated that the invention is not limited by the transition angle 26 between the wall of the combustor 10 and the plenum 24, and that the invention can be practiced with any desirable angle between zero and ninety degrees. For example, the transition angle 26 can be less than ninety degrees, as shown in FIG. 5b.

As described above, the plenum 24 lowers the “peak” of the pressure pulse, which can be harmful to downstream (and upstream) components, and extends the duration of the plateau and blowdown in the pulse detonation combustor 10.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A pulse detonation combustor having a wall and comprising at least one plenum along a length of the pulse detonation combustor for controlling one of a mechanical loading on the wall, a velocity of fluid flowing within the combustor, and a pressure generated by the pulse detonation combustor.

2. The pulse detonation combustor of claim 1, wherein the plenum has a cross-sectional area that is about 1.1 to about 2.0 times larger than the remainder of the pulse detonation chamber.

3. The pulse detonation combustor of claim 1, wherein the plenum has a cross-sectional are that is about 1.4 times larger than a cross-sectional area of the remainder of the pulse detonation chamber.

4. The pulse detonation combustor of claim 1, wherein the plenum is located proximate an air valve of the pulse detonation combustor.

5. The pulse detonation combustor of claim 1, wherein the plenum is located between a fuel injection port and an ignition source of the pulse detonation combustor.

6. The pulse detonation combustor of claim 1, wherein the plenum is located downstream of both a fuel injection port and an ignition source of the pulse detonation combustor.

7. The pulse detonation combustor of claim 1, wherein the plenum is located proximate an exit nozzle of the pulse detonation combustor.

8. The pulse detonation combustor of claim 1, wherein the pulse detonation combustor includes a plurality of plenums.

9. The pulse detonation combustor of claim 8, wherein one of the plurality of plenums is proximate an air valve of the pulse detonation combustor, and another one of the plurality of plenums is proximate an exit nozzle of the pulse detonation combustor.

10. The pulse detonation combustor of claim 1, wherein a transition angle between the plenum and the remainder of the pulse detonation combustor is less than ninety degrees.
